(19) United States
(12) Patent Application Publication
(10) Pub. No.: US 2022/0044860 A1
(43) Pub. Date: Feb. 10, 2022

(54) MAGNETIC DEVICE

(71) Applicant: Schaffner EMV AG, Luterbach (CH)

(72) Inventors: Roberto MRAD, Zuchwil (CH); Konstantinos KAZANTZIS, Drosia (GR); Luca DALESSANDRO, Zürich (CH)

(21) Appl. No.: 17/394,473

(22) Filed: Aug. 5, 2021

(30) Foreign Application Priority Data
Aug. 7, 2020 (DE) 202020104578.4

(51) Int. Cl. H01F 27/255; H01F 27/28

(52) U.S. Cl. CPC H01F 27/255; H01F 27/2823

(57) ABSTRACT

A magnetic device, such as a common-mode choke, comprising a base with a hollow stud to skewer and centre the toroidal core; and an insulating anchor with an axial bushing and a plurality of radial hooks, which is used to push the wound torpid against the base, hold the assembled device together, and insulate the windings from each other. Base and anchor are coupled and hold together through a snap-in, interlock mechanism.

### TECHNICAL DOMAIN

The present disclosure relates to magnetic devices having one or more coils of conductor wire wound on a magnetic core. A relevant mode of realization is a choke, used to block high-frequency while passing DC and lower-frequencies of alternating current, in particular a common-mode choke for blocking common-mode currents, but these are not the only possibilities, and the present model finds application also in other devices having coils wound on a magnetic core, such as simple inductors and transformers. This disclosure will address specifically a non-limiting example consisting in a three-phase common-mode unbalanced choke.

### RELATED ART

A state-of the art three-phases common-mode choke comprises three windings (plus a fourth winding for the neutral in unbalanced circuits) wound on a toroidal magnetic core. Typically, the windings are separated by a plastic spacer that ensures inter-winding electrical insulation. The windings are in most cases terminated by suitable leads for soldering on a printed circuit. Some specially demanding applications, for example in the automotive domain, require superior manufacturability, reliability, and resistance to mechanical shocks and vibrations that are difficult to attain with these conventional constructions.

### SHORT DISCLOSURE OF THE INVENTION

An aim of the present invention is the provision of a device that overcomes the shortcomings and limitations of the state of the art.

According to the invention, these aims are attained by the object of the attached claims.

### SHORT DESCRIPTION OF THE DRAWINGS

Exemplar embodiments of the invention are disclosed in the description and illustrated by the drawings in which:

FIG. 1 illustrates schematically a common-mode choke of known type,

FIG. 2 shows a common mode choke according to the claims, disassembled.

FIGS. 3a and 3b are two views of the common mode choke of FIG. 2 assembled.

FIG. 4 shows the detail marked ‘A’ in FIG. 3b.

### EXAMPLES OF EMBODIMENTS OF THE PRESENT INVENTION

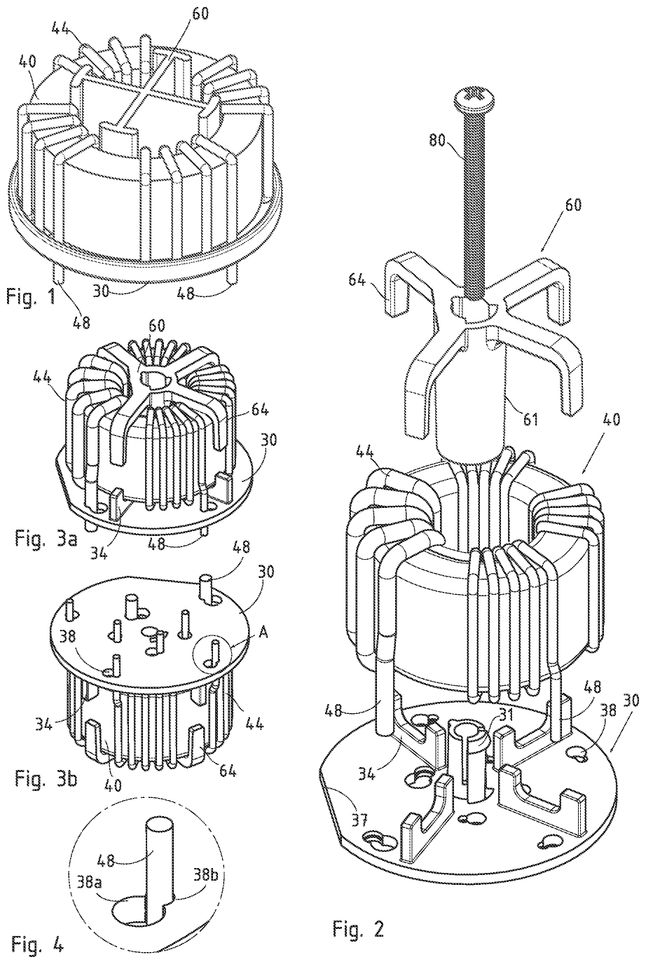

The conventional device of FIG. 1 has a solid toroidal core 40 on which are wound four coils 44, which are essentially symmetric in a common-mode choke. The core 40 could include a nanocrystalline magnetic material, for example. While each winding can be considered equipotential, the winding-to-winding potential can be significant. The coil spacer 60, made of a suitable insulating material, ensures the mutual electrical insulation between the windings 40.

The choke of FIG. 1 is mounted on an insulating base 30 and has a plurality of electric leads 48 for soldering on a printed circuit. The number of leads depends on the device but, in a four-winding choke as depicted, there may be two leads per winding, for a total of eight leads.

FIG. 2 show the claimed device, in an exploded view that exposes its constituents that include a base 30, the wound core 40, and the spacer 60. A fastener 80 can be used to improve the reliability but is not a requirement and is not part of the claimed device.

The wound core includes a plurality of windings that correspond in number and dimension to the intended application. The windings can be realized by solid enamelled wires or Litz wire, for reducing high-frequency losses, and may have parallel-connected conductors. The conductors used in the windings can have any cross-section such as, for example, round, rectangular, square, or keystone (trapezium). Importantly, the windings are organized in sectors, each sector approximatively equipotential. Adjacent sectors are separated by winding-free spaces for insulation.

The magnetic core 40 can be realized by any suitable magnetic material including for example: nanocristalline magnetic materials, ferrite, permalloy, Iron-silicon alloys, powdered magnetic materials. It has conventionally toroidal shape, but the invention is applicable to other core shapes as well. The core may comprise a single magnetic toroid, or several stacked magnetic toroids.

The windings 44 may, according to the intended use, have conductors of different cross-sections and/or occupy sectors of different sizes. The example shown is a three-phase and neutral common-mode choke, with four windings for each of the three phases and for the neutral line, arranged in four sectors. The neutral conductor is dimensioned for a higher nominal current than the three phase conductors and is therefore wound with a thicker wire, and the corresponding sector is larger. A cut-off 37 or a similar orientation aid identifies the neutral sector.

Note also that, although the presented example has the same number of wound sectors as of windings, this is not an absolute requirement, and some windings could comprise more than one wound sector of the magnetic core, externally connected.

The wound magnetic core is sandwiched between an insulating base 30 and an insulating anchor 60. The anchor has protruding arms 64 at least partially surrounding the magnetic core 40 and separating wound sectors of the magnetic core. The base 30 may have also protruding sector separators 34 corresponding to the arms 64 of the anchor. The arms 64 may develop radially from the central axis, and bend downwards to encircle the toroidal core.

The base 40 and the anchor 60 can be coupled in any suitable manner, for example by glue or adhesive. In a preferred mode of realization, the base 40 and the anchor 60 are united by a snap-on connection. The protruding stud 31 of the base interlocks with the corresponding axial bushing 61 of the anchor, and together they fit into the central hole of the toroidal core 40. A screw 80 or another suitable fastener can be inserted in a traversing axial hole of the stud 31 and of the bushing 61 for extra safety, optionally.

The windings 44 have leads 48 for connecting to an external circuit, for example by soldering on a PCB. They traverse corresponding holes 38 in the base 30. Preferably, the holes have each a first aperture 38a (visible in the detail of FIG. 4) and a smaller second aperture 38b communicating with the first one. The holes 38 are arranged on the insulating base 30 such that the leads 48 can be inserted in the first apertures of the respective holes along an axial direction, and blocked into the second apertures of the respective holes by twisting the wound magnetic core relative to the insulating base about the axial direction. In the depicted example, which has round conductors and leads, the holes 38 are pear-shaped, but this would not necessarily hold if the conductors or the leads had cross-sections of another shape, for example rectangular.

### REFERENCE SYMBOLS IN THE FIGURES

30 insulating base
31 snap-on stud
34 sector separator
37 orientation aid
38 pear-shaped holes
38a first aperture
38b second aperture
40 wound core
44 winding
48 lead
60 anchor
61 arms
64 snap-on bushing
80 screw

1. A magnetic device including a wound magnetic core on which are wound a plurality of windings organized in wound sectors, the wound magnetic core being sandwiched between an insulating base and an insulating anchor, characterized in that the anchor has protruding arms at least partially surrounding the magnetic core and separating wound sectors of the magnetic core.

2. The magnetic device of the claim 1, wherein the windings have connection leads protruding from holes of the insulating base, wherein the holes have each a first aperture and a second aperture communicating with the first aperture and smaller than the first aperture, and wherein the holes are arranged on the insulating base such that the leads can be inserted in the first apertures of the respective holes along an axial direction, and blocked into the second apertures of the respective holes by twisting the wound magnetic core relative to the insulating base about the axial direction.

3. The magnetic device of claim 1 wherein the insulating base has a first protruding element configured to fit in a central hole of the magnetic core, the anchor having a second protruding element configured to fit in the central hole of the magnetic core and to interlock together with the first protruding element.

4. The magnetic device of the claim 3, wherein the first and second protruding element are traversed by a hole allowing the insertion of a fastener.

5. The magnetic device of claim wherein the insulating base has protruding sector separators delimiting adjacent windings.

6. The magnetic device of claim 1, wherein the windings are made of conductors of different cross-sections and/or occupy sectors of different sizes.

7. The magnetic device of claim 1, wherein the windings are constituted of solid wire, Litz wire, or parallel-connected conductors.

8. The magnetic device of any one of the claim 1, wherein the windings are constituted of conductors of round, rectangular, trapezium, or square cross-section.

9. The magnetic device of claim 1, wherein the magnetic core comprises one or more of: nanocristalline magnetic material, ferrite, permalloy, Iron-silicon alloys, powdered magnetic material.

10. The magnetic device of claim 1, the magnetic core comprising one magnetic torpid, or several stacked magnetic torpids.

11. The magnetic device of claim 1, the insulating base and the anchor being glued together.

12. The magnetic device of claim 1, including an orienting aid.
